(19) United States
(12) Patent Application Publication
(10) Pub. No.: US 2018/0204184 A1
(43) Pub. Date: Jul. 19, 2018

(54) PARALLELIZED SUB-FACTOR AGGREGATION IN REAL-TIME SWARM-BASED COLLECTIVE INTELLIGENCE SYSTEMS

(71) Applicant: UNANIMOUS A. I., INC., SAN FRANCISCO, CA (US)

(72) Inventor: LOUIS B. ROSENBERG, SAN LUIS OBISPO, CA (US)

(21) Appl. No.: 15/922,453

(22) Filed: Mar. 15, 2018

Related U.S. Application Data
(63) Continuation-in-part of application No. 14/668,970, filed on Mar. 25, 2015, now Pat. No. 9,959,028.
Application No. 14/668,970 is a continuation-in-part of application No. 14/708,038, filed on May 8, 2015.
Application No. 14/708,038 is a continuation-in-part of application No. 14/738,768, filed on Jun. 12, 2015, now Pat. No. 9,940,006.
Application No. 14/738,768 is a continuation-in-part of application No. 14/859,035, filed on Sep. 18, 2015.
Application No. 14/859,035 is a continuation-in-part of application No. 14/920,819, filed on Oct. 22, 2015.
Application No. 14/920,819 is a continuation-in-part of application No. 14/925,837, filed on Oct. 28, 2015.
Application No. 14/925,837 is a continuation-in-part of application No. 15/017,424, filed on Feb. 5, 2016.
Application No. 15/017,424 is a continuation-in-part of application No. 15/047,522, filed on Feb. 18, 2016.
Application No. 15/047,522 is a continuation-in-part of application No. 15/052,876, filed on Feb. 25, 2016.
Application No. 15/052,876 is a continuation-in-part of application No. 15/086,034, filed on Mar. 30, 2016.
Application No. 15/086,034 is a continuation-in-part of application No. 15/199,990, filed on Jul. 1, 2016.
Application No. 15/199,990 is a continuation-in-part of application No. 15/241,340, filed on Aug. 19, 2016.
Application No. 15/241,340 is a continuation-in-part of application No. 15/640,145, filed on Jun. 30, 2017.
Application No. 15/640,145 is a continuation-in-part of application No. 15/815,579, filed on Nov. 16, 2017.
Application No. 15/815,579 is a continuation-in-part of application No. 15/898,468, filed on Feb. 17, 2018.
Application No. 15/898,468 is a continuation-in-part of application No. 15/904,239, filed on Feb. 23, 2018.
Application No. 15/904,239 is a continuation-in-part of application No. PCT/US15/22594, filed on Mar. 25, 2015.
Application No. PCT/US15/22594 is a continuation-in-part of application No. PCT/US15/35694, filed on Jun. 12, 2015.
Application No. PCT/US15/35694 is a continuation-in-part of application No. PCT/US15/56394, filed on Oct. 20, 2015.
Application No. PCT/US15/56394 is a continuation-in-part of application No. PCT/US16/40600, filed on Jul. 1, 2016.
Application No. PCT/US16/40600 is a continuation-in-part of application No. PCT/US17/40480, filed on Jun. 30, 2017.
Application No. PCT/US17/40480 is a continuation-in-part of application No. PCT/US17/62095, filed on Nov. 16, 2017.
(60) Provisional application No. 62/473,424, filed on Mar. 19, 2017.
(60) Provisional application No. 61/970,885, filed on Mar. 26, 2014.
(60) Provisional application No. 61/991,505, filed on May 10, 2014.
(60) Provisional application No. 62/012,403, filed on Jun. 15, 2014.
(60) Provisional application No. 62/066,718, filed on Oct. 21, 2014.
(60) Provisional application No. 62/067,505, filed on Oct. 23, 2014.
(60) Provisional application No. 62/069,360, filed on Oct. 28, 2014.
(60) Provisional application No. 62/113,393, filed on Feb. 7, 2015.
(60) Provisional application No. 62/117,808, filed on Feb. 18, 2015.
(60) Provisional application No. 62/120,618, filed on Feb. 25, 2015.
(60) Provisional application No. 62/140,032, filed on Mar. 30, 2015.
(60) Provisional application No. 62/187,470, filed on Jul. 1, 2015.
(60) Provisional application No. 62/207,234, filed on Aug. 19, 2015.
(60) Provisional application No. 62/358,026, filed on Jul. 3, 2016.
(60) Provisional application No. 62/423,402, filed on Nov. 17, 2016.
(60) Provisional application No. 62/460,861, filed on Feb. 19, 2017.
(60) Provisional application No. 62/473,442, filed on Mar. 19, 2017.
(60) Provisional application No. 62/463,657, filed on Feb. 26, 2017.
(60) Provisional application No. 62/473,429, filed on Mar. 19, 2017.

(51) Int. Cl. G06Q 10/10; H04L 29/08; G06F 17/30; H04L 29/06; G06Q 50/00

(52) U.S. Cl. CPC G06Q 10/103; H04L 67/1044; G06Q 50/01; H04L 65/403; G06F 17/30654

(57) ABSTRACT

Systems and methods are for enabling a group of individuals, each using an individual computing device, to collaboratively answer questions in real time as a unified swarm-based intelligence. The collaboration system comprises a plurality of computing devices, each of the devices being used by an individual user, each of the computing devices enabling its user to contribute to the emerging real-time group-wise intent. A collaboration server is disclosed that moderates the closed-loop system, enabling convergence upon a unified group intent. In some embodiments the group is divided into sub-groups, wherein each sub-group responds to a different sub-factor of a main prompt.

This application claims the benefit of U.S. Provisional Application No. 62/473,424 entitled PARALLELIZED SUB-FACTOR AGGREGATION IN A REAL-TIME COLLABORATIVE INTELLIGENCE SYSTEMS, filed Mar. 19, 2017, which is incorporated in its entirety herein by reference.

This application is a continuation-in-part of U.S. application Ser. No. 14/668,970 entitled METHODS AND SYSTEMS FOR REAL-TIME CLOSED-LOOP COLLABORATIVE INTELLIGENCE, filed Mar. 25, 2015, which in turn claims the benefit of U.S. Provisional Application 61/970,885 entitled METHOD AND SYSTEM FOR ENABLING A GROUPWISE COLLABORATIVE CONSCIOUSNESS, filed Mar. 26, 2014, both of which are incorporated in their entirety herein by reference.

This application is a continuation-in-part of U.S. application Ser. No. 14/708,038 entitled MULTI-GROUP METHODS AND SYSTEMS FOR REAL-TIME MULTI-TIER COLLABORATIVE INTELLIGENCE, filed May 8, 2015, which in turn claims the benefit of U.S. Provisional Application 61/991,505 entitled METHODS AND SYSTEM FOR MULTI-TIER COLLABORATIVE INTELLIGENCE, filed May 10, 2014, both of which are incorporated in their entirety herein by reference.

This application is a continuation-in-part of U.S. application Ser. No. 14/738,768 entitled INTUITIVE INTERFACES FOR REAL-TIME COLLABORATIVE INTELLIGENCE, filed Jun. 12, 2015, which in turn claims the benefit of U.S. Provisional Application 62/012,403 entitled INTUITIVE INTERFACE FOR REAL-TIME COLLABORATIVE CONTROL, filed Jun. 15, 2014, both of which are incorporated in their entirety herein by reference.

This application is a continuation-in-part of U.S. application Ser. No. 14/859,035 entitled SYSTEMS AND METHODS FOR ASSESSMENT AND OPTIMIZATION OF REAL-TIME COLLABORATIVE INTELLIGENCE SYSTEMS, filed Sep. 18, 2015 which in turn claims the benefit of U.S. Provisional Application No. 62/066,718 entitled SYSTEM AND METHOD FOR MODERATING AND OPTIMIZING REAL-TIME SWARM INTELLIGENCES, filed Oct. 21, 2014, both of which are incorporated in their entirety herein by reference.

This application is a continuation-in-part of U.S. application Ser. No. 14/920,819 entitled SUGGESTION AND BACKGROUND MODES FOR REAL-TIME COLLABORATIVE INTELLIGENCE SYSTEMS, filed Oct. 22, 2015 which in turn claims the benefit of U.S. Provisional Application No. 62/067,505 entitled SYSTEM AND METHODS FOR MODERATING REAL-TIME COLLABORATIVE DECISIONS OVER A DISTRIBUTED NETWORKS, filed Oct. 23, 2014, both of which are incorporated in their entirety herein by reference.

This application is a continuation-in-part of U.S. application Ser. No. 14/925,837 entitled MULTI-PHASE MULTI-GROUP SELECTION METHODS FOR REAL-TIME COLLABORATIVE INTELLIGENCE SYSTEMS, filed Oct. 28, 2015 which in turn claims the benefit of U.S. Provisional Application No. 62/069,360 entitled SYSTEMS AND METHODS FOR ENABLING AND MODERATING A MASSIVELY-PARALLEL REAL-TIME SYNCHRONOUS COLLABORATIVE SUPER-INTELLIGENCE, filed Oct. 28, 2014, both of which are incorporated in their entirety herein by reference.

This application is a continuation-in-part of U.S. application Ser. No. 15/017,424 entitled ITERATIVE SUGGESTION MODES FOR REAL-TIME COLLABORATIVE INTELLIGENCE SYSTEMS, filed Feb. 5, 2016 which in turn claims the benefit of U.S. Provisional Application No. 62/113,393 entitled SYSTEMS AND METHODS FOR ENABLING SYNCHRONOUS COLLABORATIVE CREATIVITY AND DECISION MAKING, filed Feb. 7, 2015, both of which are incorporated in their entirety herein by reference.

This application is a continuation-in-part of U.S. application Ser. No. 15/047,522 entitled SYSTEMS AND METHODS FOR COLLABORATIVE SYNCHRONOUS IMAGE SELECTION, filed Feb. 18, 2016 which in turn claims the benefit of U.S. Provisional Application No. 62/117,808 entitled SYSTEM AND METHODS FOR COLLABORATIVE SYNCHRONOUS IMAGE SELECTION, filed Feb. 18, 2015, both of which are incorporated in their entirety herein by reference.

This application is a continuation-in-part of U.S. application Ser. No. 15/052,876 entitled DYNAMIC SYSTEMS FOR OPTIMIZATION OF REAL-TIME COLLABORATIVE INTELLIGENCE, filed Feb. 25, 2016 which in turn claims the benefit of U.S. Provisional Application No. 62/120,618 entitled APPLICATION OF DYNAMIC RESTORING FORCES TO OPTIMIZE GROUP INTELLIGENCE IN REAL-TIME SOCIAL SWARMS, filed Feb. 25, 2015, both of which are incorporated in their entirety herein by reference.

This application is a continuation-in-part of U.S. application Ser. No. 15/086,034 entitled SYSTEM AND METHOD FOR MODERATING REAL-TIME CLOSED-LOOP COLLABORATIVE DECISIONS ON MOBILE DEVICES, filed Mar. 30, 2016 which in turn claims the benefit of U.S. Provisional Application No. 62/140,032 entitled SYSTEM AND METHOD FOR MODERATING A REAL-TIME CLOSED-LOOP COLLABORATIVE APPROVAL FROM A GROUP OF MOBILE USERS filed Mar. 30, 2015, both of which are incorporated in their entirety herein by reference.

This application is a continuation-in-part of U.S. application Ser. No. 15/199,990 entitled METHODS AND SYSTEMS FOR ENABLING A CREDIT ECONOMY IN A REAL-TIME COLLABORATIVE INTELLIGENCE, filed Jul. 1, 2016, which in turn claims the benefit of U.S. Provisional Application No. 62/187,470 entitled METHODS AND SYSTEMS FOR ENABLING A CREDIT ECONOMY IN A REAL-TIME SYNCHRONOUS COLLABORATIVE SYSTEM filed Jul. 1, 2015, both of which are incorporated in their entirety herein by reference.

This application is a continuation-in-part of U.S. application Ser. No. 15/241,340 entitled METHODS FOR ANALYZING DECISIONS MADE BY REAL-TIME INTELLIGENCE SYSTEMS, filed Aug. 19, 2016, which in turn claims the benefit of U.S. Provisional Application No. 62/207,234 entitled METHODS FOR ANALYZING THE DECISIONS MADE BY REAL-TIME COLLECTIVE INTELLIGENCE SYSTEMS filed Aug. 19, 2015, both of which are incorporated in their entirety herein by reference.

This application is a continuation-in-part of U.S. application Ser. No. 15/640,145 entitled METHODS AND SYSTEMS FOR MODIFYING USER INFLUENCE DURING A COLLABORATIVE SESSION OF REAL-TIME COLLABORATIVE INTELLIGENCE SYSTEM, filed Jun. 30, 2017, which in turn claims the benefit of U.S. Provisional Application No. 62/358,026 entitled METHODS AND SYSTEMS FOR AMPLIFYING THE INTELLIGENCE OF A HUMAN-BASED ARTIFICIAL SWARM INTELLIGENCE filed Jul. 3, 2016, both of which are incorporated in their entirety herein by reference.

This application is a continuation-in-part of U.S. application Ser. No. 15/815,579 entitled SYSTEMS AND METHODS FOR HYBRID SWARM INTELLIGENCE, filed Nov. 16, 2017, which in turn claims the benefit of U.S. Provisional Application No. 62/423,402 entitled SYSTEM AND METHOD FOR HYBRID SWARM INTELLIGENCE filed Nov. 17, 2016, both of which are incorporated in their entirety herein by reference.

This application is a continuation-in-part of U.S. application Ser. No. 15/898,468 entitled ADAPTIVE CONFIDENCE CALIBRATION FOR REAL-TIME SWARM INTELLIGENCE SYSTEMS, filed Feb. 17, 2018, which in turn claims the benefit of U.S. Provisional Application No. 62/460,861 entitled ARTIFICIAL SWARM INTELLIGENCE WITH ADAPTIVE CONFIDENCE CALIBRATION, filed Feb. 19, 2017 and also claims the benefit of U.S. Provisional Application No. 62/473,442 entitled ARTIFICIAL SWARM INTELLIGENCE WITH ADAPTIVE CONFIDENCE CALIBRATION, filed Mar. 19, 2017, all of which are incorporated in their entirety herein by reference.

This application is a continuation-in-part of U.S. application Ser. No. 15/904,239 entitled METHODS AND SYSTEMS FOR COLLABORATIVE CONTROL OF A REMOTE VEHICLE, filed Feb. 23, 2018, which in turn claims the benefit of U.S. Provisional Application No. 62/463,657 entitled METHODS AND SYSTEMS FOR COLLABORATIVE CONTROL OF A ROBOTIC MOBILE FIRST-PERSON STREAMING CAMERA SOURCE, filed Feb. 26, 2017 and also claims the benefit of U.S. Provisional Application No. 62/473,429 entitled METHODS AND SYSTEMS FOR COLLABORATIVE CONTROL OF A ROBOTIC MOBILE FIRST-PERSON STREAMING CAMERA SOURCE, filed Mar. 19, 2017, all of which are incorporated in their entirety herein by reference.

This application is a continuation-in-part of International Application No. PCT/US15/22594, filed Mar. 25, 2015.

This application is a continuation-in-part of International Application No. PCT/US15/35694, filed Jun. 12, 2015.

This application is a continuation-in-part of International Application No. PCT/US15/56394, filed Oct. 20, 2015.

This application is a continuation-in-part of International Application No. PCT/US16/40600, filed Jul. 1, 2016.

This application is a continuation-in-part of International Application No. PCT/US17/40480, filed Jun. 30, 2017.

This application is a continuation-in-part of International Application No. PCT/US2017/062095, filed Nov. 16, 2017.

### BACKGROUND OF THE INVENTION

### 1. Field of the Invention

The present invention relates generally to systems and methods for real-time swarm-based collective intelligence, and more specifically to systems and methods for real-time closed-loop dynamic collaborative control systems.

### 2. Discussion of the Related Art

For hundreds of years, people have assessed the will of groups by taking polls, surveys, and votes. While such methods can reveal the most popular sentiments, they do not generally converge on optimized aggregations when determining the combined views, opinions, decisions, predictions, or insight of groups. The difference between the most popular solution (i.e. the Crowd-Based solution) and the optimal solution which maximizes the collective sentiment of the group (i.e. the Swarm-Based solution) has been demonstrated in numerous research studies by the present inventor, showing that swarm-based intelligence outperforms crowd-based intelligence. For example, in a study entitled “Crowds vs Swarms: a comparison of intelligence” by the present inventor, a real-time closed-loop swarm of 29 networked people significantly outperformed the predictive power of a statistical crowd of 469 people using traditional polling techniques.

In some cases, a question posed to a group of users may be broken up into sub-parts or sub-questions. Combining the answers of those sub-questions into a single answer to the overall question then requires aggregation, requiring further steps that happen in series. Methods like Analytic Hierarchy Process (AHP) exist in the field of group decision making, but they require large numbers of decisions to be generated in series, which is time consuming and non-optimal.

### SUMMARY OF THE INVENTION

Several embodiments of the invention advantageously address the needs above as well as other needs by providing a method for decision-making by a collaborative intent system including a plurality of computing devices, each computing device associated with a user of a group of users and running a collaborative intent application and in communication with a central collaboration server running a collaboration mediation application, comprising the steps of: determining a set of sub-factors related to a question to be decided by the group of users, wherein the question has an associated set of answer choices; ranking the sub-factors in order of importance for the evaluation of the question; determining a rating value for each sub-factor; performing a collaboration session for each sub-factor and set of answer choices, each collaboration session comprising: displaying, using a display interface of each computing device, information for the sub-factor collaboration session, the information including a set of targets, each target associated with one answer choice, a graphical pointer having a coordinate location relative to the set of targets, and a question associated with the sub-factor; repeatedly receiving user input of a user intent vector through each display interface, the user intent vector having a direction in relation to the set of targets and a magnitude; repeatedly sending the user intent vector to the collaboration server; repeatedly determining, by the collaboration server, of an updated pointer coordinate location from the plurality of user intent vectors; repeatedly sending the updated pointer coordinate location to each of the plurality of computing devices; and in response to receiving the updated pointer coordinate location, repeatedly updating the display of the graphical pointer relative to the set of targets, whereby one sub-answer is selected from the set of answer choices; determining a weighting factor for each sub-factor based on the rating value; and determining a final answer choice based on the weighting factor and the answer choice selected for each sub-factor.

In another embodiment, the invention can be characterized as a parallelized method for decision-making by a collaborative intent system including a plurality of computing devices, each computing device associated with a user of a group of users and running a collaborative intent application and in communication with a central collaboration server running a collaboration mediation application, comprising the steps of: determining a set of sub-factors related to a question to be decided by the group of users, wherein the question has an associated set of answer choices; dividing the group of users into sub-groups, wherein each sub-group is associated with one sub-factor; and performing a collaboration session comprising: displaying, using a display interface of each computing device, information for the collaboration session, the information including a set of targets, each target associated with one answer choice, a graphical pointer having a coordinate location relative to the set of targets, and a question associated with the sub-factor associated with the sub-group of each user; repeatedly receiving user input of a user intent vector through each display interface, the user intent vector having a direction in relation to the set of targets and a magnitude; repeatedly sending the user intent vector to the collaboration server; repeatedly determining, by the collaboration server, of an updated pointer coordinate location from the plurality of user intent vectors; repeatedly sending the updated pointer coordinate location to each of the plurality of computing devices; and in response to receiving the updated pointer coordinate location, repeatedly updating the display of the graphical pointer relative to the set of targets; and collaboratively selecting one answer choice when the corresponding target locations is within a central area of the updated pointer coordinate location for at least a threshold amount of time.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a schematic diagram of an exemplary real-time collaboration system in one embodiment of the present invention.

FIG. 2 is a schematic diagram of a computing device in one embodiment of the collaboration system.

FIG. 3 is an exemplary target board shown in accordance with one embodiment of the present invention.

FIG. 4 is an exemplary target board shown in accordance with another embodiment of the present invention.

FIG. 5 is a flowchart for an exemplary sub-factor decision-making process in another embodiment of the present invention.

FIGS. 6-8 comprises exemplary target boards of the sub-factor decision-making process of FIG. 5.

FIG. 9 is a flowchart of a method for a parallelized sub-factor decision-making process in another embodiment of the present invention.

FIG. 10 is an exemplary schematic diagram of the parallelized sub-factor decision-making process of FIG. 9.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As described in the related applications by the present inventor, which are incorporated by reference, methods and systems for enabling a real-time closed-loop collective intelligence among a plurality of networked users are disclosed. The methods and systems enable a plurality of networked users to participate in a real-time process in which a question or other textual prompt (written or verbal) is presented in substantial simultaneity to each of the networked users on each of a plurality of local computing device. In addition to the prompt, a set of possible responses to be selected among is presented to each of the networked users on each of the plurality of local computing devices. The local computing devices are in communication with a central collaboration server (CCS) that coordinates the synchronous display of questions and choices to the plurality of users by the plurality of local computing devices. The system and methods of the present invention enable the plurality of networked users to respond to the prompt as a unified dynamic system, collectively selecting one response from the set of possible responses. In many embodiments, the users do this through real-time closed-loop control of a collaborative pointer in which the plurality of users work in synchrony to move the pointer from a starting location to a location associated with the selected response. In many preferred embodiments, the users impart their individual intent with respect to the motion of the collaboratively controlled pointer by positioning a graphical magnet that defines the magnitude and direction of a user intent vector. The CCS receives a plurality of user intent vectors and determines a group intent vector (or equivalent resultant) that influences the motion of the collaboratively controlled pointer in real-time.

In this way, the present invention enables a plurality of users to work together as a real-time closed-loop collaborative intelligence that expresses a singular group intent that can answer questions, make decisions, produce forecasts, generate predictions, or otherwise provide collective responses to a textual prompt. The methods intervening software and hardware to moderate the process, closing the loop around the disparate input from each of the many individual participants and the singular output of the group. The output is not necessarily the most popular answer that you might get from a common poll or vote, but instead finds the local maxima of collective satisfaction or conviction. In other words, it finds the solution that the group can best support even if that solution is not the most popular single option. This has shown in research studies to be highly effective, outperforming votes and polls and surveys in reaching optimized decisions, forecasts, and predictions.

In many embodiments, each individual user (“participant”) engages the user interface on a computing device, conveying his or her individual real-time intent with respect to the motion of the collaboratively controlled pointer, while simultaneously watching the real-time motion resulting from the group intent. This closes the loop around each user, for he is conveying individual intent while also reacting to the group's emerging will.

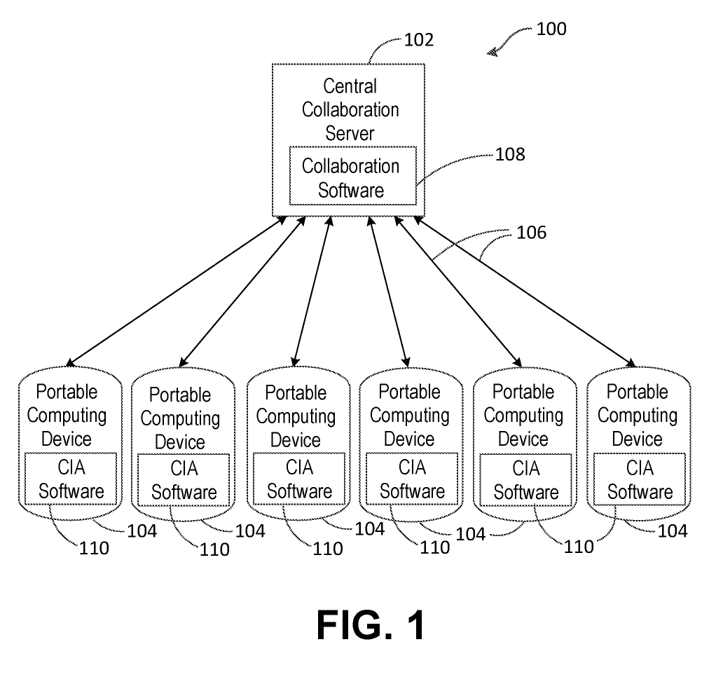

Referring to FIG. 1, a schematic diagram of an exemplary collaboration system 100 is shown. Shown are a Central Collaboration Server (CCS) 102, a plurality of computing devices 104, a plurality of exchanges of data (106) with the Central Collaboration Server 102, a collaboration software 108, and a plurality of collaborative intent applications 110. Embodiments of the plurality of portable computing devices 104 and the interaction of the computing devices 104 with the system 100 are previously disclosed in the related patent applications.

As shown in FIG. 1, the system 100 comprises the Central Collaboration Server (CCS) 102 running the collaboration software 108 and in communication (via the plurality of exchanged of data 106) with the plurality of computing devices 104, each of said computing devices 104 running the Collaborative Intent Application (“CIA”) software 110. The system 100 is designed to enable the plurality of users, each engaging an interface of one of said computing devices 104, to jointly control a single graphical element, for example a movable pointer, through real-time group-wise collaboration. In some embodiments, such as a multi-tier architecture, the portable computing devices 104 may communicate with each other. The CCS 102 includes the collaboration software 108 and additional elements as necessary to perform the required functions. In this application, it will be understood that the term “CCS” may be used to refer to the software of the CCS 102 or other elements of the CCS 102 that are performing the given function.

Although multiple pointers controlled by multiple closed-loop groups is enabled by the innovations of the present invention, examples are presented herein that are confined to a single closed-loop group. This is for simplicity of description and is not intended to limit the scope of the innovations. Also, reference is made herein to sub-portions of a single closed-loop group. Because these sub-portions are part of the same closed-loop system, the sub-portions are referred to as “sub-groups” herein, meaning the sub-groups are part of the same closed-loop real-time system that is manipulating the same collaboratively controlled pointer, but are identified as sub-sets of that group which are addressed uniquely by the CCS to enable some of the inventive methods of the present application.

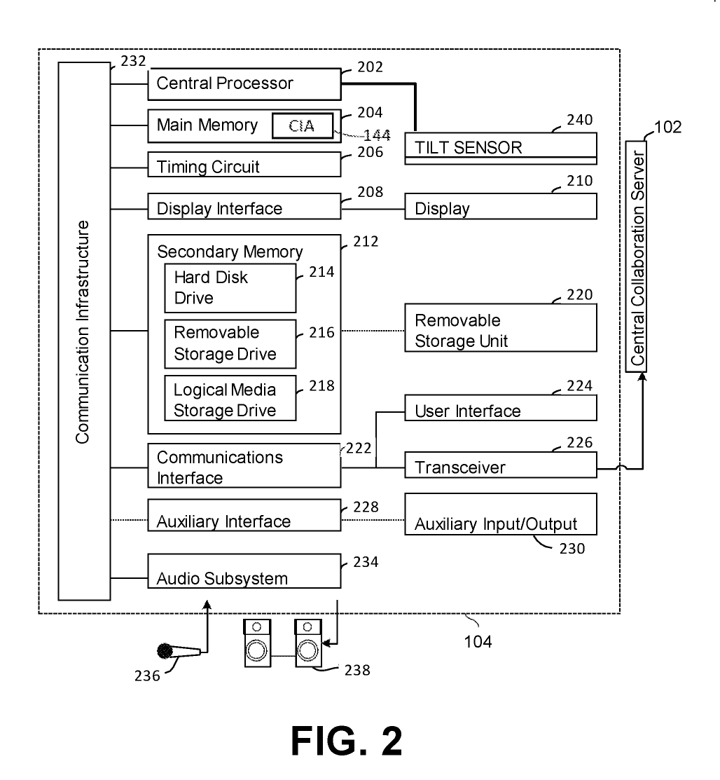

Referring again to FIG. 1, each of the computing devices 104 comprises one or more processors capable of running the CIA 110 routines and displaying a representation of a pointer along with a plurality of graphical input choices. The computing device 104 could be, for example, a personal computer running the CIA 110. The computing device 104 could also be a mobile device such as a smart phone, tablet, headset, smart-watch, or other portable computing device running the CIA 110. The CIA software code can be configured as a stand-alone executable or be code that executes inside a web-browser or other shell. An exemplary computing device is described further below in FIG. 2.

While FIG. 1 shows only six computing devices 104 in communication with the CCS 102, the system 100 is highly scalable, enabling hundreds, thousands, or even millions of users to connect simultaneously to the CCS 102, each using their own computing device 104, thereby sharing a real-time collaborative experience with the other users. In this way, large numbers of users can collaboratively control the pointer to generate a response as a group intelligence.

While FIG. 1 shows simple top-down architecture for direct communication between the CCS 102 and each of the computing devices 104, related application Ser. No. 14/708,038 entitled MULTI-GROUP METHODS AND SYSTEMS FOR REAL-TIME MULTI-TIER COLLABORATIVE INTELLIGENCE discloses multi-group and tiered architectures that enable shared processing loads among large numbers of computing devices 104. While FIG. 1 shows a dedicated CCS 102, the system 100 can be configured such that one of the computing devices 104 acts as the CCS 102 by running both CCS routines and CIA routines. Such a model is generally viable only when the number of users is low. Regardless of the architecture used, each of said computing devices 104 that is engaged by a participating user includes one or more display devices for presenting a graphical user interface to the user.

Referring next to FIG. 2, a schematic diagram of the computing device 104 in one embodiment of the collaboration system is shown. Shown are a central processor 202, a main memory 204, a timing circuit 206, a display interface 208, a display 210, a secondary memory subsystem 212, a hard disk drive 214, a removable storage drive 216, a logical media storage drive 218, a removable storage unit 220, a communications interface 222, a user interface 224, a transceiver 226, an auxiliary interface 228, an auxiliary I/O port 230, communications infrastructure 232, an audio subsystem 234, a microphone 236, headphones 238, a tilt sensor 240, the central collaboration server 102, and the collaborative intent application 110.

As shown previously in FIG. 1, each of the plurality of computing devices 104, each used by one of a plurality of users (the plurality of users also referred to as a group), is networked in real-time to the central collaboration server (CCS) 102. In some embodiments, one of the computing devices 104 could act as the central collaboration server 102. For the purposes of this disclosure, the central collaboration server 102 is its own computer system in a remote location, and not the computing device 104 of one of the users. Hence the collaboration system is comprised of the centralized central collaboration server 102 and the plurality of computing devices 104, each of the computing devices 104 used by one user.

The computing device 104 may be embodied as a handheld unit, a pocket housed unit, a body worn unit, or other portable unit that is generally maintained on the person of a user. In other embodiments the computing device may be a generally stationary device such as a desktop computer or workstation. The computing device 104 may be wearable, such as transmissive display glasses.

The central processor 202 is provided to interpret and execute logical instructions stored in the main memory 204. The main memory 204 is the primary general purpose storage area for instructions and data to be processed by the central processor 202. The main memory 204 is used in the broadest sense and may include RAM, EEPROM and ROM. The timing circuit 206 is provided to coordinate activities within the computing device 104. The central processor 202, main memory 204 and timing circuit 206 are directly coupled to the communications infrastructure 232. The central processor 202 may be configured to run a variety of applications, including for example phone and address book applications, media storage and play applications, gaming applications, clock and timing applications, phone and email and text messaging and chat and other communication applications. The central processor 202 is also configured to run at least one Collaborative Intent Application (CIA) 110. The Collaborative Intent Application 110 may be a standalone application or may be a component of an application that also runs upon other networked processors.

The computing device 104 includes the communications infrastructure 232 used to transfer data, memory addresses where data items are to be found and control signals among the various components and subsystems of the computing device 104.

The display interface 208 is provided upon the computing device 104 to drive the display 210 associated with the computing device 104. The display interface 208 is electrically coupled to the communications infrastructure 232 and provides signals to the display 210 for visually outputting both graphics and alphanumeric characters. The display interface 208 may include a dedicated graphics processor and memory to support the displaying of graphics intensive media. The display 210 may be of any type (e.g., cathode ray tube, gas plasma) but in most circumstances will usually be a solid state device such as liquid crystal display. The display 210 may include a touch screen capability, allowing manual input as well as graphical display.

Affixed to the display 210, directly or indirectly, may be the tilt sensor 240 (accelerometer or other effective technology) that detects the physical orientation of the display 210. The tilt sensor 240 is also coupled to the central processor 202 so that input conveyed via the tilt sensor 240 is transferred to the central processor 202. The tilt sensor 240 provides input to the Collaborative Intent Application 110. Other input methods may include eye tracking, voice input, and/or manipulandum input.

The secondary memory subsystem 212 is provided which houses retrievable storage units such as the hard disk drive 214 and the removable storage drive 216. Optional storage units such as the logical media storage drive 218 and the removable storage unit 216 may also be included. The removable storage drive 216 may be a replaceable hard drive, optical media storage drive or a solid state flash RAM device. The logical media storage drive 218 may be a flash RAM device, EEPROM encoded with playable media, or optical storage media (CD, DVD). The removable storage unit 220 may be logical, optical or of an electromechanical (hard disk) design.

The communications interface 222 subsystem is provided which allows for standardized electrical connection of peripheral devices to the communications infrastructure 232 including, serial, parallel, USB, and Firewire connectivity. For example, the user interface 224 and the transceiver 226 are electrically coupled to the communications infrastructure 232 via the communications interface 222. For purposes of this disclosure, the term user interface 224 includes the hardware and operating software by which the user executes procedures on the computing device 104 and the means by which the computing device 104 conveys information to the user. In the present invention, the user interface 224 is controlled by the CIA 110 and is configured to display information regarding the group collaboration, as well as receive user input and display group output.

To accommodate non-standardized communications interfaces (i.e., proprietary), the optional separate auxiliary interface 228 and the auxiliary I/O port 230 are provided to couple proprietary peripheral devices to the communications infrastructure 232. The transceiver 226 facilitates the remote exchange of data and synchronizing signals between the computing device 104 and the Central Collaboration Server 102. The transceiver 226 could also be used to enable communication among a plurality of computing devices 104 used by other participants. In some embodiments, one of the computing devices 104 acts as the Central Collaboration Server 102, although the ideal embodiment uses a dedicated server for this purpose. In one embodiment the transceiver 226 is a radio frequency type normally associated with computer networks for example, wireless computer networks based on BLUETOOTH® or the various IEEE standards 802.11.sub.x., where x denotes the various present and evolving wireless computing standards. In some embodiments the computing devices 104 establish an ad hock network between and among them, as with a BLUETOOTH® communication technology.

It should be noted that any prevailing wireless communication standard may be employed to enable the plurality of computing devices 104 to exchange data and thereby engage in a collaborative consciousness process. For example, digital cellular communications formats compatible with for example GSM, 3G, 4G, and evolving cellular communications standards. Both peer-to-peer (PPP) and client-server models are envisioned for implementation of the invention. In a third alternative embodiment, the transceiver 226 may include hybrids of computer communications standards, cellular standards and evolving satellite radio standards.

The audio subsystem 234 is provided and electrically coupled to the communications infrastructure 232. The audio subsystem 134 is configured for the playback and recording of digital media, for example, multi or multimedia encoded in any of the exemplary formats MP3, AVI, WAV, MPG, QT, WMA, AIFF, AU, RAM, RA, MOV, MIDI, etc.

The audio subsystem 234 in one embodiment includes the microphone 236 which is used for the detection and capture of vocal utterances from that unit's user. In this way the user may issue a suggestion as a verbal utterance. The computing device 104 may then capture the verbal utterance, digitize the utterance, and convey the utterance to other of said plurality of users by sending it to their respective computing devices 104 over the intervening network. In this way, the user may convey a suggestion verbally and have the suggestion conveyed as verbal audio content to other users. It should be noted that if the users are in close physical proximity the suggestion may be conveyed verbally without the need for conveying it through an electronic media. The user may simply speak the suggestion to the other members of the group who are in close listening range. Those users may then accept or reject the suggestion using their computing devices 104 and taking advantage of the tallying, processing, and electronic decision determination and communication processes disclosed herein. In this way the present invention may act as a supportive supplement that is seamlessly integrated into a direct face to face conversation held among a group of users.

For embodiments that do include the microphone 236, it may be incorporated within the casing of the computing device 104 or may be remotely located elsewhere upon a body of the user and is connected to the computing device 104 by a wired or wireless link. Sound signals from microphone 236 are generally captured as analog audio signals and converted to digital form by an analog to digital converter or other similar component and/or process. A digital signal is thereby provided to the processor 202 of the computing device 104, the digital signal representing the audio content captured by microphone 236. In some embodiments the microphone 236 is local to the headphones 238 or other head-worn component of the user. In some embodiments the microphone 236 is interfaced to the computing device 104 by a Bluetooth® link. In some embodiments the microphone 236 comprises a plurality of microphone elements. This can allow users to talk to each other, while engaging in a collaborative experience, making it more fun and social. Allowing users to talk to each other could also be distracting and could be not allowed.

The audio subsystem 234 generally also includes headphones 238 (or other similar personalized audio presentation units that display audio content to the ears of a user). The headphones 238 may be connected by wired or wireless connections. In some embodiments the headphones 238 are interfaced to the computing device 104 by the Bluetooth® communication link.

The computing device 104 includes an operating system, the necessary hardware and software drivers necessary to fully utilize the devices coupled to the communications infrastructure 232, media playback and recording applications and at least one Collaborative Intent Application 110 operatively loaded into main memory 204, which is designed to display information to a user, collect input from that user, and communicate in real-time with the Central Collaboration Server 102. Optionally, the computing device 104 is envisioned to include at least one remote authentication application, one or more cryptography applications capable of performing symmetric and asymmetric cryptographic functions, and secure messaging software. Optionally, the computing device 104 may be disposed in a portable form factor to be carried by a user.

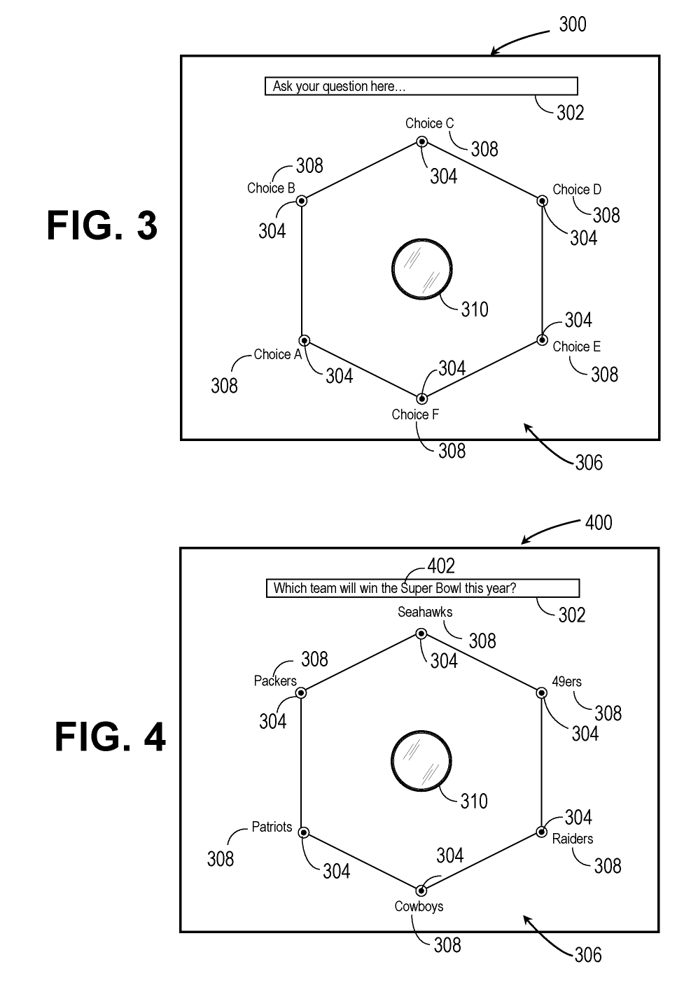

Referring next to FIG. 3, an exemplary target board 300 is shown in accordance with one embodiment of the present invention. Shown are a prompt bar 302, a plurality of target locations 304, a target area 306, a plurality of input choices (also referred to as answer choices) 308, and a collaboratively controller pointer 310.

The collectively controlled graphical pointer 310 is simultaneously displayed to each user by the CIA software running on his or her computing device 104. The pointer 310 displayed to each user appears in a substantially similar position with respect to the set of target locations 304 (as compared to the position of the pointer 310 on other user's screens). Each target location 304 is associated with one input choice/answer choice 308. The synchrony of the interfaces is coordinated by the data 106 received by each computing device 104 sent from the CCS 102 over the communications link. In a current embodiment, data 106 is sent from the CCS 102 to each of the plurality of computing devices 104 at a rate of 60 updates per second, the data 106 including the current position of the graphical pointer 310 (also referred to herein as a puck) with respect to the set of graphical target locations 304, as further shown below. Coordination data may also include orientation information.

In general, the input choices 308 and target locations 304 are identically displayed upon all the computing devices 104, although some unique embodiments allow for divergent input choices 308. For example, in some embodiments the input choices 308 are displayed in the native language of each user, each input choice 308 conveying a substantially similar verbal message, but translated based on a language setting of the user. This feature enables groups of individuals who speak different languages and are unable to communicate directly, to still form a collective intelligence that can collaboratively answer questions. In such embodiments, the displayed questions are also automatically translated into the chosen native language of the user. This is also true of a displayed answer, and optionally a chat window output.

In some embodiments, multiple graphical pointers 310 are displayed by the computing devices 104, each of said graphical pointers 310 being collaboratively controlled by a different group of users. For example, 500 users may be collaboratively controlling Graphical Pointer #1, while a different group of 500 users are collaboratively controlling Graphical Pointer #2. The first group of 500 users comprises a first collective intelligence. The second group of 500 users comprises a second collective intelligence. This unique system and methods allow for the first swarm-based collective intelligence to compete with the second swarm-based collective intelligence in a task that is displayed to all 1000 users on each of their computing devices 104. For example, one collective intelligence can be enabled to compete with another collective intelligence in a real-time trivial competition, performed head-to-head, simultaneously—group against group.

As shown in FIG. 3, the CIA software running on each computing device 104 is configured to display the graphical target board 300 (as presented to the user as by the display interface 208) that includes at least one collectively controlled graphical pointer 310, the plurality of spatially arranged graphical target locations 304, and the plurality of input choices 308, each input choice 308 associated with one target location 304. In the exemplary target board 300, the graphical pointer 310 is configured to look like a “glass puck” with a central viewing area that is transparent. In the example shown, the target locations 304 are configured as a hexagon of six target locations 304, each target location 304 associated with one input choice 308, a word or phrase or image. In this case, the six target locations 304 correspond with the six input choices 308: “Choice A”, “Choice B”, “Choice C”, “Choice D”, “Choice E”, and “Choice F”. These are shown as place holders, as they'd be replaced by text representing the various answer choices when an actual question is asked. For example, if the question prompt shown in the prompt bar 302 was “Who will win the world series?” the choices might be “Yankees”, “Mets”, “Red Sox”, “Giants”, “Dodgers”, and “White Sox”. The group of users, working as a real-time closed loop system, would collaboratively control the pointer 310 to select one of the choices, thereby answering the question as swarm intelligence.

More specifically, when the collectively controlled pointer 310 is positioned over one of the input choices 308 such that the target locations 304 is substantially within a centralized viewing area of the pointer 310 for more than a threshold amount of time the input choice 308 associated with the target location 304 is selected as the answer to the prompt. In common embodiments the threshold amount of time is 3 to 5 seconds. In the current embodiment, the centralized viewing area appears as a graphical etching on the glass pointer 310, the etching remaining invisible until the pointer 310 approaches a target.

As shown in the exemplary embodiment of FIG. 3, the graphical input choices 308 can comprise words, phrases, numbers, or images. In this example, if the pointer 310 is positioned over one of the six target locations 304 for more than the threshold amount of time, the associated input choice 308 is selected as the answer to a previously asked question. To ask a question, the user enters the question into the prompt bar 302. In one embodiment, once entered, the user clicks an “ask” button, which sends the question from the CIA software 110 of that particular user (running on his local computing device 104) to the CCS 102. Because many users could ask questions, the CCS 102 acts as the gate keeper, deeming the first question received (when no question is currently in process) as the one that will be asked to the group. In the current embodiment, not all users are enabled to ask questions at any given time to avoid too much competition for asking. In some embodiments, only designated “moderators” are enabled to ask questions, as defined by permissions assigned to users indicating which users are moderators. As disclosed in the related applications, in some embodiments users must spend credits to ask questions, and can only ask if he has enough credits. In some embodiments, users earn credits based on points awarded for participation in a session. More credits are awarded to users who have high participation scores, less credits being awarded to users with low participation scores.

As disclosed in the related applications, in addition to asking questions, users can select from a plurality of possible display interfaces by using a board selection drop-down menu displayed on the target board. One standardized target board has choices defined to support yes/no questions. Other target boards may include choices that support true/false questions, good/bad questions, and other sets of standardized answers. As disclosed in related applications, custom boards can also be entered by selecting “custom” from the board selection drop-down menu. Also, “suggestion mode” can also be selected for a given question through the board selection drop-down menu which asks other users in the plurality of users to give suggestions that populate the board in real-time.

In some embodiments, as previously disclosed in the related applications, users can selectively use a physics mode from a physics selection drop-down menu displayed on the target board. A standard physics mode can be selected where the pointer moves in accordance to standard physics. An ice mode can be selected where the pointer 310 slides around on the target board as if it were frictionless ice. A gravity mode can be selected, which is configured to pull the pointer 310 back to the center of the target location set (i.e. center screen) as if by simulated gravity. In a heavy mode the pointer has substantially higher mass than in standard mode and thus is harder for users to move. In a barrier mode, a set of physical barriers block a direct path to the target locations 304, forcing users to collaboratively guide the pointer around barriers to reach the target locations 304.

When an exemplary question is entered by one of the users in the group (for example, a designated moderator), the question is sent by the CIA 110 on that user's computing device 104 to the CCS 102. If the CCS 102 software determines that the question is valid, the question is then sent to all the users in the group so that it appears substantially simultaneously on the display interface 208 of each of the computing devices 104. In a current embodiment, the question appears in a large box at the top of the target board. Then a “3”-“2”-“1” countdown timer appears at the center of the target board, notifying users get ready for the collaborative answer process, or session, to begin. The display interface 208 (having received instructions from the CCS 102) then displays a graphical “GO” and the users will then collaboratively control the motion of the pointer 310, guiding it towards whichever input choice best satisfies the collaborative will of the group as emergent from the real-time collective intelligence. As disclosed in related applications incorporated herein by reference, the collaborative control may be implemented by each user imparting a real-time intent regarding a desired motion of the puck 310 by manipulating a graphical magnet on his or her local computing device 194. The graphical magnet defines a magnitude and direction of the user's personal intent, referred to herein as a User Intent Vector.

Each collaborative session is generally limited in total time by the underlying software of the present system 100, for example giving the group intelligence 60 seconds to converge upon an answer through the collaborative motion of the pointer 310. This time pressure is deliberate, for it inspires users to employ their gut instincts and intuitions rather than overthinking the question. To support the use of time-pressure, a countdown clock may be displayed on the group display interface 208 of each user, the timing of the plurality of countdown clocks coordinated by handshaking signals from the CCS 102. If the pointer 310 does not reach the target location 304 within the allotted 60 seconds, the system 100 determines that the collaboration is a failure, and sends a failure indication to the CIA 110 of each computing device 104. In some embodiments, in response to receiving the failure indication the CIA 110 terminates user input and displays the words “brain freeze!” on the display interface 208. In addition, in response to receiving the failure indication all users could lose a number of points and/or credits for the collective failure of the group to guide the pointer 310 to the target location 304.

The system 100 is configured to determine that a target is achieved when the group successfully positions the pointer 310 over one target location 304 for more than the threshold period of time. When the group targets one target location 304, the associated input choice 308 is displayed on the display 210 of all the users as the answer to the question. The time period from the start of the question (i.e. when the word “GO” appears on the plurality of computers) and when the target location 304 is selected, is referred to herein as the Decision Period. During the decision period, the group of users works as a real-time dynamic system to move the puck 310 from the staring location of the selection as described in detail in the related applications which have been incorporated by reference.

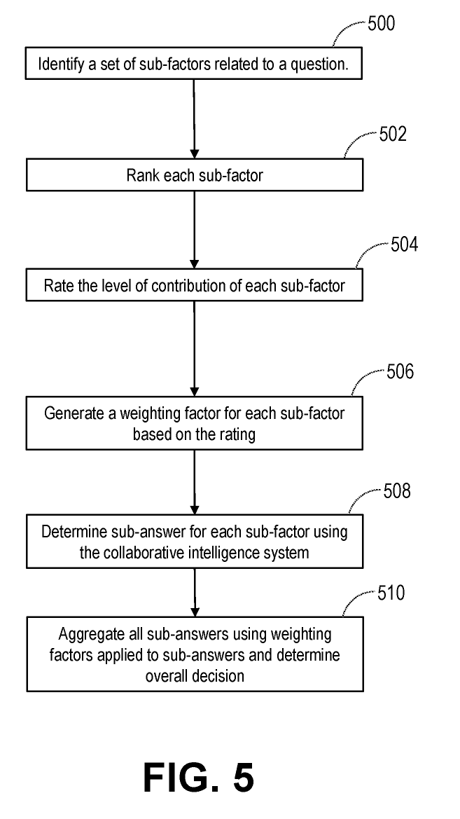

Referring next to FIG. 4, an exemplary target board 400 presented by the display interface 208 on the display 210 is shown. A question 402 is presented in the prompt bar 302 that was entered by a moderator appears on the displays 210 of the group of participating users in substantial simultaneity. The question is sent from the CCS 102 to the computing devices 104 associated with each of the users in the group, wherein he CIA 110 running on the computing devices 104 of each user is configured to receive and display the question 402 (i.e. the prompt) and the set of target locations 304 and input choices 308. In this example, the question 402 is displayed as text—“Which team will win the Super Bowl this year?” The input choices 308 are displayed as unique text options: “Patriots”-“Packers”-“Seahawks”-“49ers”-“Raiders”-“Cowboys”. The users of the group, each networked from unique locations, each using their own computing device 104, then work together as a real-time swarm intelligence, to move the puck 310 and select an optimized answer to the question. This process is described in detail in the related applications.

### Sub-Factor Methods

The above process works well, but what if the question that requires an answer, prediction, decision, or forecast can be broken up into sub-questions? For example, what if the question “WHICH TEAM WILL WIN THE SUPER BOWL THIS YEAR?” Can be broken up into sub-questions that contribute to this overall decision? Exemplary sub-questions for the above question could include:

1) Which team has the best Offense this year?

2) Which team has the best Defense this year?

3) Which team has the best Quarterback this year?

4) Which team will have the least injuries this year?

5) Which team will have the least turnovers this year?

If we know that the team that is most likely to win the Super Bowl is some combination of these five sub-questions, we may want to tap the intelligence of the optimized collaborative intelligence described herein using each of those five questions, then aggregate the result. We refer to these sub-questions as “sub-factors” herein, as they may not be worded only as questions.

Thus, we may want to take a single question or prompt and break it up into a set of sub-questions or prompts that address a set of sub-factors of the overall question or prompt, and then aggregate the results to produce a single optimized solution. To do this, a number of inventive methods have been developed and are disclosed herein.

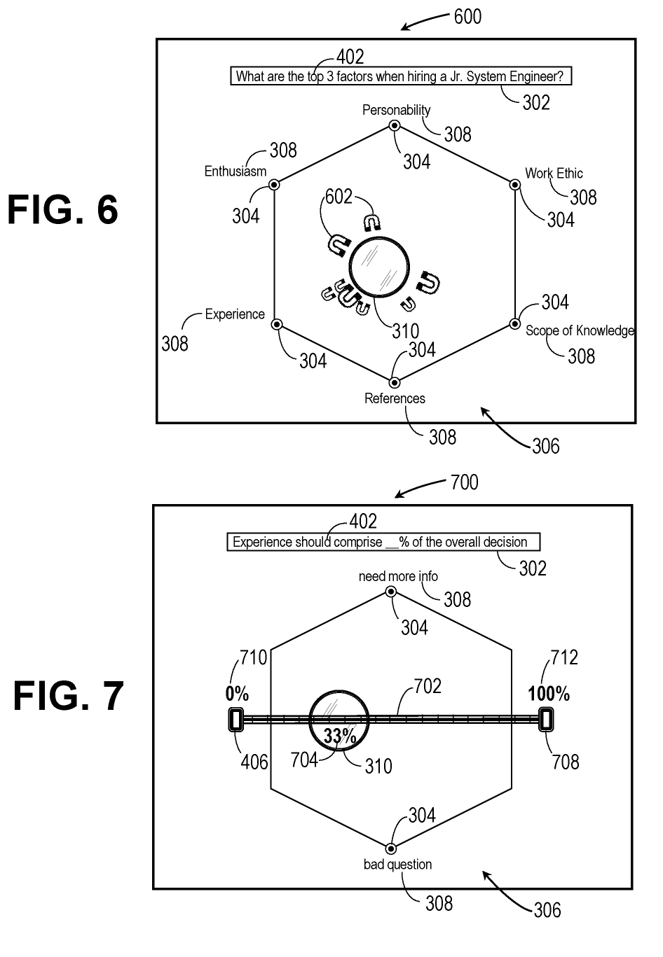

Referring next to FIG. 5, a flowchart for an exemplary sub-factor decision-making process is shown. In the initial identify sub-factor step 500, a set of sub-factors is identified that contribute to a high-level question or prompt for which an overall answer is desired. In one embodiment the sub-factors are determined by the CCS 102. In other embodiments, the sub-factors are determined by input one or more users and/or moderators.

In the next rank sub-factors step 502, the sub-factors are ranked in order of importance in relation to the question. In some embodiment, the sub-factors are ranked using repeated swarm-based collaboration sessions, wherein during each session the group selects the most important sub-factor of the remaining sub-factors (or alternatively by selecting first the least important sub-factor, then selected the next-least important sub-factor, etc.). Ranking accounts for the sub-factors being likely to have differing impact level upon the solution to the high-level prompt. In some embodiments, the sub-factors are ranked by input from one or more users and/or moderators.

Next, in the rate sub-factors step 504, each sub-factor is given a rating of 0-100%, the rating representing the level of contribution that each of the ranked sub-factors has to the overall high-level question or prompt. In one embodiment, the rating for each sub-factor is determined using a swarm-based collaboration session, for example the swarm-based collaboration session as described below in FIG. 7.

In the next generate weighting factor step 506, a weighting factor is generated for each sub-factor based on the ratings from the previous rate sub-factor step 504. In some embodiments, the weighting factors are determined by the CCS 102.

Next, in the determine sub-answers step 508, a swarm-based collaboration session is run for each sub-factor, wherein the group selects an answer for the sub-factor from a plurality of input choices for that sub-factor. The input choices for the sub-factor collaboration sessions may be the same for all sub-factors, or may vary between sub-factors. The answer for each sub-factor collaboration session is the sub-answer for that sub-factor.

Finally, in the determine overall decision step 510, the CCS 102 aggregates the sub-answers using the weighting factors determined in the generate weighting factor step 506 to produce an overall result. The result may be a single answer, or an ordered list of results.

Referring again to FIG. 5, in the rank sub-factors step 502, the swarm-based collaborative intelligence system can be used to create a ranked list of the sub-factors. That ranked list, from most important to least important, might be:

1^{st}—Which team has the best Quarterback this year?

2^{nd}—Which team has the best Offense this year?

3^{rd}—Which team has the best Defense this year?

4^{th}—Which team will have the least injuries this year?

5^{th}—Which team will have the least turnovers this year?

Then, in the next rate sub-factor step 504, each of these sub-factors are given a percentage of importance. This is done by first running a swarm-based collaboration session resulting in a percentage from 0 to 100% for the first sub-factor in the ranked list. Once the swarm gives a percent answer for the first listed sub-factor, the remaining percentage is then asked for the second sub-factor on the list, and so on. In the current example, the swarm intelligence would be asked “How important to the likelihood of the team winning the super bowl is the quarterback sub-factor?” and would be given a range 0% to 100% to select from. The swarm, via the collaboration session, then selects 40% for the rating of the first sub-factor. The swarm would then be asked, “How important to the likelihood of the team winning the super bowl is the Offense sub-factor?” and would be given a range 0% to 60%. (Note, the 60% limit is used because that's all that's left now that the first sub-factor has been assigned 40% consequence). The percentage selections continue until a set of importance percentages are defined for the set of sub-factors that have been identified and ranked. In the current example, this might result in the following:

40% importance—Quarterback

20% importance—Offense

12% importance—Defense

6% importance—injuries

2% importance—turnovers

These contribution level ratings can then be used directly as the weighting factors in the aggregation of the sub-factor predictions made by the collaborative intelligence. In some embodiments the importance percentages are further modified to obtain the weighting factors. It should also be noted that in some embodiments, the ranking and/or rating of the sub-factors can be performed by a moderator. Thus steps 500, 502 and/or 504 could be performed by a moderator that is overseeing the process. That said, to achieve maximal intelligence, using the collaborative system is most likely to achieve optimized results.

Once a set of sub-factors and weighting factors has been determined, the final steps 508 and 510 can be performed: having the collaborative intelligence assess the set of choices with respect to each of the sub-factors in the determine sub-answers step 508, and generate a final solution to the overall question by aggregating the answers to the sub-factor assessments by using the weighting factors in the determine overall decision step 510. Also used in the aggregation may be performance metrics generated from data collected during the collective intelligence decision process. For example, a conviction index (CVi) may be used in the determine overall decision step 510. When a swarm-based intelligence system converges on an answer, performance metrics are captured that indicate the degree of conviction within the system, giving insights into the strength of the result. Brainpower is one metric (generally reported as 0 to 100%) while the conviction index is a normalized version of brainpower. Specifically, the speed of convergence and the degree of alignment among the swarm participants during a response is used to compute brainpower and the conviction index (CVi). Speed of convergence is how long it takes for the collaboratively controlled pointer to settle upon and select an answer. Degree of alignment is based upon the time-average of user intent vector directions, over the question answering period. For example, if everyone was pulling in exactly the same direction during the 20 seconds it took to reach an answer, alignment would be 100%. If everyone was pulling in different directions, perfectly canceling each other out during those 20 second, the degree of alignment would be 0%. The brainpower is a percentage between 0% and 100%, computed based upon both the speed of convergence and the degree of alignment. The conviction index is the brainpower divided by 100 so that the conviction index is a number between 0.0 and 1.0. The CVi value of 1 is the theoretical case where every member of the swarm is closely aligned in sentiment during the full duration of the response and all members express maximum conviction in that response. Conversely, a CVi value of 0 is the case where the swarm has such strong divergence among participants, the process stagnates and no decision is reached within the conviction index is a single value generated for a single session (i.e. question that is answered by puck moving to an answer).

The aggregation of the answers to the sub-factor assessments can be performed using a purely statistical aggregation, but as will be described later in this document—a highly inventive method has been developed to perform this aggregation in parallel, using a single response rather than a response for multiple sub-factors in series.

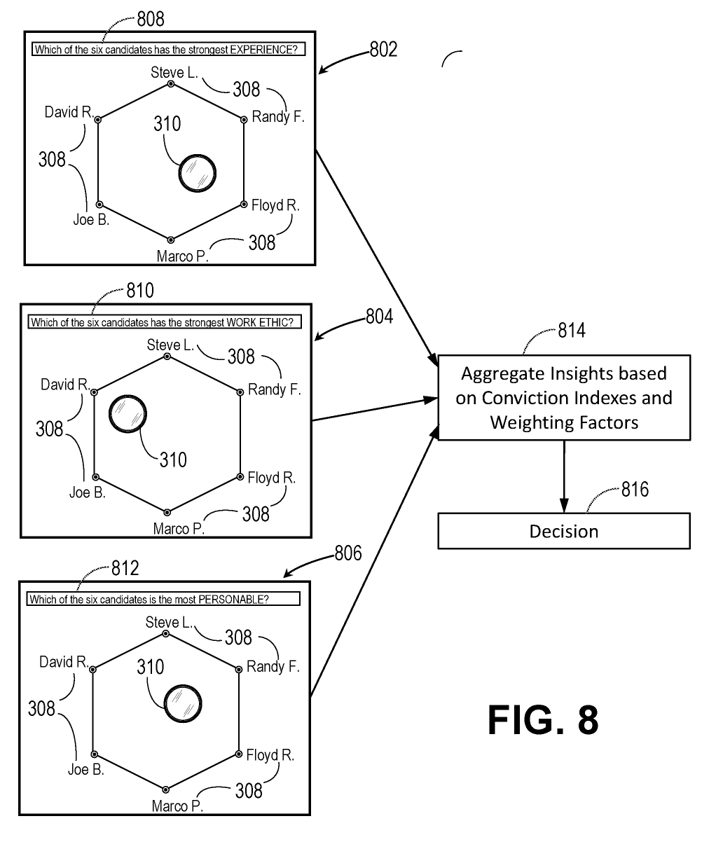

Referring next to FIGS. 6-8, an example of the process of FIG. 5 is shown. FIG. 6 shows an exemplary target board 600 during the identify sub-factor step 500 step 500. FIG. 7 shows an exemplary target board 700 during the rate sub-factors step 504, and FIG. 8 shows exemplary target boards 808, 810, and 812 during the determine sub-answers step 508. FIG. 8 also shows an aggregate insights step 814 and a decision step 816, in one embodiment of the overall decision step 510.

FIGS. 6-8 illustrate the sub-factor decision-making process of FIG. 5 for a business group of 21 participants, each using their own computing device, all networked together as a unified intelligence to make a hiring decision to select from among six potential hiring candidates. As shown in FIG. 6 during the identify sub-factor step 500 the 21 participants to work together as a real-time closed-loop system to first rank the important sub-factors in the hiring decision. In this example, the group collaboratively selects EXPERIENCE, WORK ETHIC, and PERSONABILITY as the three most important sub-factors in the hiring decision through a series of collaboration sessions.

Then, as shown in FIG. 7, the group of 21 participants, each using their own computing device, all networked together as a unified intelligence, harness their collective intelligence to assess the relative importance of these three sub-factors. The group determines, in this example, through the series of collaboration sessions, that EXPERIENCE is 33% of the importance. Work Ethic is 40% of the importance. And the remainder, 27% of the importance is assigned to PERSONABILITY.

In addition, Conviction Index values (or other values based on performance metrics) are generated during each real-time closed-loop response. The Conviction Index value associated with each sub-factor may be optionally used in the aggregation. In this case, the Conviction Index is used to scale the importance percentages to derive the final weighting factors. In the present example, the result of applying the conviction index values to the importance percentages to obtain the final weighting factors is shown below in Table 1.

TABLE 1

| | | Adjusted Importance |
|---|---|---|
| | Importance | Percentage |
| Sub-Factor | Percentage | (Weighting Factor) |
| Experience | 33% | 38% |
| Work Ethic | 40% | 38% |
| Personability | 27% | 24% |

Once these steps are completed, the swarm intelligence still needs to select an answer for each of the sub-factors. In the hiring example above, this means the swarm intelligence would, in three collaboration sessions, answer three questions (prompts) with respect to the input choices 308 (job candidates). FIG. 8 shows exemplary target boards during each of the sub-factor collaboration sessions: An experience sub-factor target board 802 (asking an experience question 808), a work ethic sub-factor target board 804 (asking a work ethic questions 810), and a personability sub-factor target board 806 (asking a personability question 812). Each target board 802, 804, 806 displays the plurality of input choices 308, in this example the names of the six candidates.

Once the group, via the swarm-based collaboration sessions, selects a sub-answer for each of the three sub-factors, an aggregated solution to the overall question (the hiring decision) is then generated by using the weighting factors in the aggregate insights step 814. This will produce a final answer to the overall hiring decision. In the present example, in the final decision step 816 the CCS 102 will produce an ordered list of the six candidates, from best to worst, based on the three sub-factor assessments and associated weighting values, all generated by the collaborative swarm intelligence using the collaborative systems and methods.

As illustrated in FIG. 8, the sub-factor decision-making process of FIG. 5 requires that each of the sub-factors be assessed in series by having the group of participants who comprise the real-time closed-loop system evaluate the choices with respect to each sub-factor in sequential collaboration sessions. Using collaboration sessions in series requires more time, and also requires that the answers from the three sub-factor evaluations be aggregated statistically, rather than via a collaboration session.

Therefore, in some embodiments an inventive method has been devised that enables aggregation, not as a statistical artifact, but by converging as a unified closed-loop system.

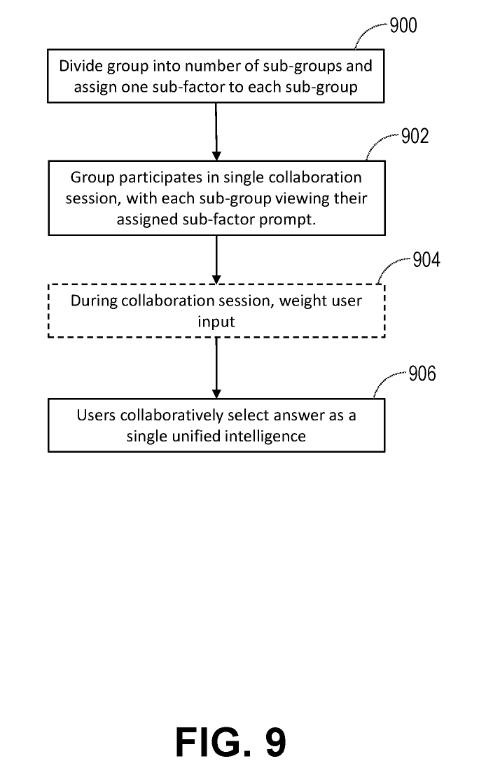

Referring next to FIG. 9, a flowchart for a parallelized sub-factor decision-making process is shown.

In the first subgroup step 900, the group of users is divided into a number of subgroups equal to the number of sub-factors, and a different sub-factor is assigned to each subgroup. In some embodiments, the number of users in each subgroup is proportional to the importance percentage of the corresponding subgroup. For example, for a group of 100 users, if sub-factor A has an importance percentage of 50%, sub-factor B has an importance percentage of 30%, and sub-factor C has an importance percentage of 20%, subgroup A will have 50 members, subgroup B will have 30 members, and subgroup C will have 20 members. In other embodiments, the users are divided equally among the subgroups.

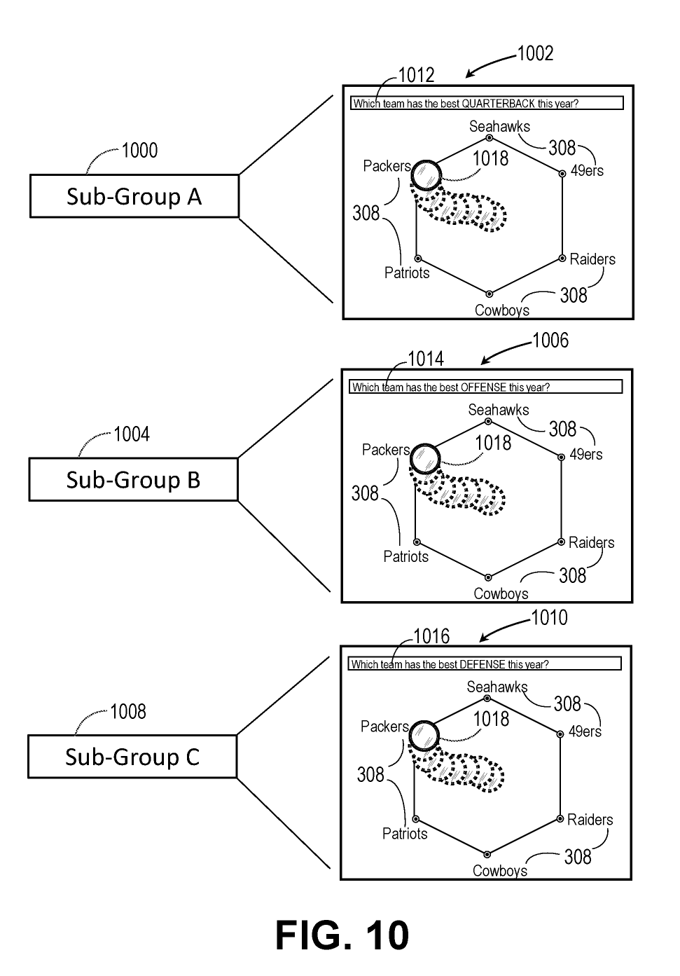

In the next parallelized collaboration session step 902, the overall group participates in a swarm-based collaboration session. All users in the group view the position and movement of the graphical pointer 310 substantially the same across all computing devices. Additionally, all of the users see target locations 304 in substantially the same locations across all computing devices 104, and user inputs for all users are used to determine the movement of the single graphical pointer 310 to one of the target locations 304. However, each subgroup views a different sub-factor question during the collaboration session. This is described further below in FIG. 10.

During the collaboration session, in the optional weight user input step 904 the user input (i.e. the user intent vector) generated by each user is weighted before combining the plurality of user inputs to generate the group intent vector and the updated pointer location. In one embodiment, each user input is weighted based on the importance percentage of the sub-factor associated with the user's subgroup.

In the final select answer step 906, the collaboration session results in the group collaboratively selecting one target location 304, resulting in an answer of the input choice 308 associated with that target location 304.

Referring again to FIG. 9, the parallelized sub-factor decision-making process is a unique innovation to the collaboration system 100 which enables the group of users to be broken up into sub-groups, each of which sees a different question prompt, yet all of whom are still working together as a unified system to collaboratively move the single graphical pointer. During the parallelized sub-factor decision-making process, all of the users are shown the graphical pointer 310 in substantially the same position, all of the users are shown target locations 304 in substantially the same locations, and all of the users work together to move the pointer 310 to one of the target locations as a unified system. However, each subgroup views a different sub-factor question. Because of this, during the parallelized sub-factor decision-making process the group is working as a human-machine aggregation system such that the group is aggregating the sub-factors in parallel as a unified system during the single collaboration session. This enables them to converge, in synchrony, on the optimal solution.

In addition, to account for the importance percentages that convey the relative importance of the different sub-factors, inventive methods are used to weight the impacts that the members of each sub-group have on the motion of the movable puck 310 based on which question (i.e. which sub-factor) they are evaluating.

This enables a group of individuals to form a complex human swarm, that converges on the optimal answer to a complex question, wherein multiple sub-groups assess multiple factors of the complex question, as the individuals work together as a single unified system to reach an optimal unified answer, their relative impacts weighted by the importance of the sub-factor each is assessing.

Referring next to FIG. 10, a schematic diagram for an exemplary parallelized sub-factor decision-making process is shown during a collaboration session.

In this example, a group of 30 individuals, each using their own computing device 104, are participating as a real-time closed-loop system that collaboratively controls a movable pointer in response to a prompt, such that the group works together as a system to answer a question by collaboratively positioning the pointer on one target location. In the embodiment shown, the pointer 1018 (an embodiment of the previously described pointer 310) is shown with the same movement and locations across all sub-groups 1000, 1004, 1008, as illustrated by the sub-group target boards 1002, 1006, 1016. In target boards 1002, 1006, 1010, the pointer 1018 is in the same position relative to the target locations, and has had the same movement, as illustrated by the dashed trail of the pointer 1018 indicating previous movement due to the pointer location being continually updated.

The group of 30 individuals in this example are combining their collective intelligence as a unified system to predict who will win the Super Bowl this year. In this example it has been determined (by the group or by a moderator) the sub-factors and importance percentages that go into this prediction. The sub-factors and importance percentages are shown below in Table 2.

TABLE 2

| | Importance |
|---|---|
| Sub-Factor | Percentage |
| Quarterback | 50% |
| Offense | 30% |
| Defense | 20% |

Three sub-questions (i.e. sub-factors), each of a different relative importance, go into the overall question of which team will win the Super Bowl this year. The current invention allows the single unified collaborative intelligence system, comprised of the full 30 person group, to reach a single decision that combines these three sub-factors in parallel. Applying the process of FIG. 9 in this example results in the following steps:

First, in the first subgroup step 900 the 30-person group is broken up into three smaller subgroups, each subgroup assigned to one of the three sub-factors that go into the high-level question of which team will win the Super Bowl. In this example the sub-groups are named sub-group A 1000, sub-group B 1003, and sub-group C 1008.

Next, in the parallelized collaboration session step 902 all members of the group participate in the collaboration session as a single unified system, all working together to move the puck 310 to one of the target locations 304 such that all participants see the same target locations and associated answer choices 308. And all participants see the movable pointer at the same relative location with respect to the choices. As illustrated in FIG. 10, during the collaboration session a sub-group A target board 1002 is shown to sub-group A, a sub-group B target board 1006 is shown to sub-group B 1004, and a sub-group C target board 1010 is shown to sub-group C 1008. Thus, all participants can work together as a system to move the puck 310 to the best possible choice, using the method already disclosed herein and in related applications. What is different and unique and extremely powerful is that in this example, each sub-group sees a different question displayed on the target board, while working as the same system. In the example of FIG. 10, the members of sub-group A 1000 see a sub-group A question 1012 “Which team will have the best QUARTERBACK this year?”. The members of sub-group B 1004 see a sub-group B question 1014 “Which team will have the best OFFENSE back this year?”. The members of sub-group C 1008 see a sub-group C question 1016 “Which team will have the best OFFENSE back this year?”.

As shown in FIG. 10, all users see the same choices 308, and the same motion of the puck 310, but each sub-group is shown a different prompt 1012, 1014, 1016. In this way, the users are working together as a single unified intelligence, thus aggregating the sub-factors in parallel as the users contemplate the options (with respect to the different sub-factors) and converge together on a unified decision or solution.

During the real-time closed-loop collaboration process in which the 30 participants move the graphical pointer 310 to select one of the input choices 308 displayed on the target boards 1002, 1006, 1010, the relative impact of each sub-group 1000, 1004, 1008 is weighted based on the importance percentage of the sub-factor that sub-group is responding to, as dictated by the importance weighting factors shown. There are two inventive methods for doing this, which can be used alone or in combination.

In a first method, impact of each sub-group 1000, 1004, 1008 is affected by the size of each sub-group as created in step 900. In this method, the CCS 102 assigns a number of users to each sub-group 1000, 1004, 1008 based on the weighting factor of the sub-factor associated with that sub-group. Thus, a proportionally larger sub-group is used for a sub-factor that has a higher weighting factor, and a proportionally smaller sub-group is used for a sub-factor that has a lower weighting factor. In the current example, the sub-group sizes are as shown below in Table 3:

TABLE 3

| Sub-Factor | Weighting Factor | Sub-group Size |
|---|---|---|
| Quarterback | 50% | 15 users |
| Offense | 30% | 9 users |
| Defense | 20% | 6 users |

Because each user has the potential to contribute an equal impact level upon the movable pointer 310 during the collaboration session, by assigning more users to the Quarterback sub-factor, proportional to its weighting factor, the quarterback sub-factor is given appropriate weighting in the unified closed-loop real-time intelligence system.

In a second method, the optional weight user input step 904 is used. In the first subgroup step 900, generally equal sub-groups sizes are created. In subsequent step 904 the user input of each user is weighted based on the weighting factor but to weight the impact of the members of each subgroup based on the weighting factor associated with that sub-group. As each user imparts the user input vector upon the movable pointer 310, as disclosed in related applications in detail, this inventive process scales the user input vector of each member of the sub-group based on the weighting factor. associated with that sub-group.

While many embodiments are described herein, it is appreciated that this invention can have a range of variations that practice the same basic methods and achieve the novel collaborative capabilities that have been disclosed above. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for decision-making by a collaborative intent system including a plurality of computing devices, each computing device associated with a user of a group of users and running a collaborative intent application and in communication with a central collaboration server running a collaboration mediation application, comprising the steps of:
determining a set of sub-factors related to a question to be decided by the group of users, wherein the question has an associated set of answer choices;
ranking the sub-factors in order of importance for the evaluation of the question;
determining a rating value for each sub-factor;
performing a sub-factor collaboration session for each sub-factor using the set of answer choices, each collaboration session comprising:
displaying, using a display interface of each computing device, information for the sub-factor collaboration session, the information including a set of targets, each target associated with one answer choice, a collaboratively controlled graphical pointer having a coordinate location relative to the set of targets, and a sub-factor question associated with the sub-factor;
repeatedly receiving user input from each computing device of a user intent vector, each user intent vector having a direction in relation to the set of targets and a magnitude;
repeatedly sending each user intent vector to the collaboration server;
repeatedly determining, by the collaboration server, of an updated pointer coordinate location from the plurality of user intent vectors;
repeatedly sending the updated pointer coordinate location to each of the plurality of computing devices; and
in response to receiving the updated pointer coordinate location, on each of the computing devices repeatedly updating the display of the graphical pointer relative to the set of targets, whereby one sub-answer is selected from the set of answer choices;
determining a weighting factor for each sub-factor based on the rating value; and
determining a final answer choice from the set of answer choices based on the weighting factors and the sub-answers.

2. The method for decision-making of claim 1 wherein ranking the sub-factors includes multiple additional collaboration sessions, wherein in each additional collaboration session the group of users identifies which sub-factor is most important from at least a portion of the set of sub-factors.

3. The method for decision-making of claim 1 wherein the set of sub-factors is determined by a moderator of the group of users.

4. The method for decision-making of claim 1 wherein determining the rating value for each sub-factor includes a collaboration session for each sub-factor, wherein in each collaboration session the group of users selects an importance percentage for that sub-factor.

5. The method for decision-making of claim 4 wherein the weighting factor is based on the importance percentage.

6. The method for decision-making of claim 1, wherein the determining the final answer choice is additionally based on a conviction index of the group.

7. The method for decision-making of claim 1, wherein the determining of the weighting factor for each sub-factor is additionally based on a conviction index of each sub-group.

8. A parallelized method for decision-making by a collaborative intent system including a plurality of computing devices, each computing device associated with a user of a group of users and running a collaborative intent application and in communication with a central collaboration server running a collaboration mediation application, comprising the steps of:
determining a set of sub-factors related to a question to be decided by the group of users, wherein the question has an associated set of answer choices;
dividing the group of users into sub-groups, wherein each sub-group is associated with one sub-factor; and
performing a collaboration session comprising:
displaying, using a display interface of each computing device, information for the collaboration session, the information including a set of targets, each target associated with one answer choice, a graphical pointer having a coordinate location relative to the set of targets, and a sub-question associated with the sub-factor associated with the sub-group of that user;
repeatedly receiving user input from each computing device of a user intent vector, the user intent vector having a direction in relation to the set of targets and a magnitude;
repeatedly sending each user intent vector to the collaboration server;
repeatedly determining, by the collaboration server, of an updated pointer coordinate location from the plurality of user intent vectors;
repeatedly sending the updated pointer coordinate location to each of the plurality of computing devices; and
in response to receiving the updated pointer coordinate location, repeatedly updating the display of the graphical pointer relative to the set of targets; and
collaboratively selecting one answer choice when the corresponding target location is within a central area of the updated pointer coordinate location for at least a threshold amount of time.

9. The parallelized method for decision-making of claim 8, wherein each sub-group has a weighting factor associated with the sub-group.

10. The parallelized method for decision-making of claim 9, wherein a size of each sub-group is proportional to the weighting factor of that sub-group.

11. The parallelized method for decision-making of claim 9, wherein each sub-group has an importance percentage associated with that sub-group, and the weighting factor is based on the importance percentage.

12. The parallelized method for decision-making of claim 9, wherein the sub-groups are of generally equal size.

13. The parallelized method for decision-making of claim 12, wherein during the collaboration session each user intent vector is weighted according to the weighting factor for the sub-group of that user.
